(19) United States
(12) Patent Application Publication
(10) Pub. No.: US 2014/0114756 A1
(43) Pub. Date: Apr. 24, 2014

(54) ADVERTISEMENT DISTRIBUTION APPARATUS, AND ADVERTISEMENT DISTRIBUTION METHOD

(71) Applicant: YAHOO JAPAN CORPORATION, Tokyo (JP)

(72) Inventors: Masamine TAKAHASHI, Tokyo (JP); Miho FUJII, Tokyo (JP); Shigeo UCHIDA, Tokyo (JP)

(73) Assignee: YAHOO JAPAN CORPORATION, Tokyo (JP)

(21) Appl. No.: 14/021,528

(22) Filed: Sep. 9, 2013

(30) Foreign Application Priority Data
Oct. 18, 2012 (JP) 2012-230626

(51) Int. Cl. G06Q 30/02

(52) U.S. Cl. CPC G06Q 30/0267
USPC 705/14.53

(57) ABSTRACT

A storage unit 61 stores user card information 70 that stores information on a user who creates an electronic point card in a mobile terminal 11 and information on the electronic point card and advertisement information 71 of a store where the point card can be used. A distributing unit 82 distributes advertisement information of the store where the electronic point card created in the mobile terminal of the user can be used to an information processing device used by the user who created the electronic point card in the mobile terminal 11 and who is indicated in the user card information 70.

### CROSS-REFERENCE TO RELATED APPLICATIONS

The present application claims priority to and incorporates by reference the entire contents of Japanese Patent Application. No. 2012-230626 filed in Japan on Oct. 18, 2012

### BACKGROUND OF THE INVENTION

1. Field of the Invention

The present invention relates to an advertisement distribution apparatus, and an advertisement distribution method.

2. Description of the Related Art

Many users carry point cards and present the point cards at a store to get an incentive such as giving a point, using a point, or discounting of a price. The point cards can be used in determined stores. When a user wants to get an incentive at various stores, the user needs to carry various point cards of the stores, which is difficult. Thus, electronic point cards have been created. Electronic point cards provide merits in that there is no need to possess physical point cards. Moreover, when a point card is stored electronically in a mobile terminal with the aid of an application program, it is possible to induce users of the mobile terminals to visit stores by presenting advertisements to the mobile terminals of the users, for example. For example, Japanese Patent Application Laid-open No. 2007-213281 discloses a technique of transmitting a coupon to a mobile terminal of a user, reading the coupon at a store, and giving a point to the user.

However, the user may erase or skip the advertisement distributed to the mobile terminal without reading the advertisement or may change an application notification setting so that advertisements are not displayed. Thus, it may be difficult to sufficiently notify the user of advertisements and to induce the user to visit the store.

### SUMMARY OF THE INVENTION

It is an object of the present invention to at least partially solve the problems in the conventional technology.

According to one aspect of an embodiment of the present invention, an advertisement distribution apparatus includes: a card information storage unit that stores store information and identification information of the user as information on an electronic point card issued to a mobile terminal of a user; an advertisement storage unit that stores advertisement information of the store; a specifying unit that specifies a user who uses an information processing device through user authentication; and a distributing unit that reads advertisement information of a store corresponding to the point card issued to the mobile terminal of the user from the advertisement storage unit and distributes the advertisement information to the information processing device when the user specified by the specifying unit is a user identified by the identification information stored in the card information storage unit.

The above and other objects; features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram schematically illustrating an overall configuration of a system according to an embodiment;

FIG. 2 is a diagram illustrating an example of a functional configuration of a mobile terminal according to the embodiment;

FIG. 3 is a diagram illustrating an example of data configuration of a card information table according to the embodiment;

FIG. 4 is a diagram illustrating an example of a functional configuration of a server device according to the embodiment;

FIG. 5 is a diagram illustrating an example of data configuration of user card information according to the embodiment;

FIG. 6 is a diagram illustrating an example of data configuration of advertisement information according to the embodiment;

FIG. 7 is a diagram illustrating an example of a data configuration of distribution history information according to the embodiment;

FIG. 8 is a diagram illustrating an example of a data configuration of charge information according to the embodiment;

FIG. 9 is a flowchart illustrating the flow of an advertisement distributing process according to the embodiment;

FIG. 10 is a flowchart illustrating the flow of a charging process according to the embodiment; and

FIG. 11 is a diagram illustrating another example of a functional configuration of a server device according to the embodiment.

### DETAILED DESCRIPTION OF THE PREFERRED EMBODIMENTS

Hereinafter, an advertisement distribution apparatus, an advertisement distribution method, and an advertisement distribution program according to an exemplary embodiment (hereinafter, referred to as an “embodiment”) of the present invention will be described in detail with reference to the accompanying drawings. The invention is not limited to the embodiment.

1. System Configuration

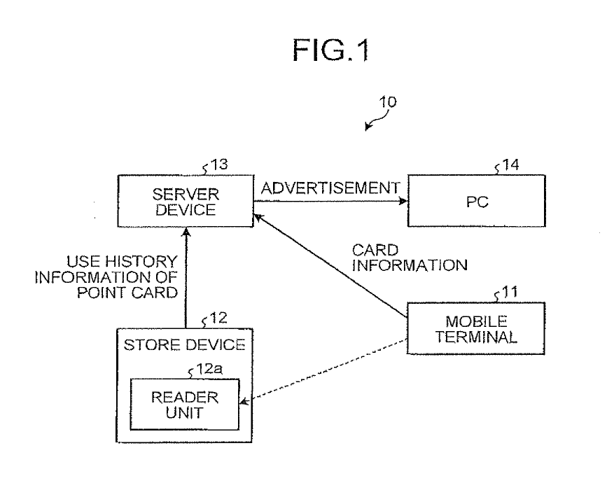

An embodiment will be described. FIG. 1 is a diagram schematically illustrating an overall configuration of a system according to the embodiment. As illustrated in FIG. 1, a system 10 includes a mobile terminal 11, a store device 12, a server device 13, and a personal computer (hereinafter, referred to also as a “PC”) 14. The mobile terminal 11 and the server device 13, the store device 12 and the server device 13, and the server device 13 and the PC 14 each are communicably connected via a network (not illustrated). Examples of the network include an optional communication network such as the Internet, a local area network (LAN), a virtual private network (VPN), or a mobile communication network regardless of whether the network is a cable network or a wireless network. In the example of FIG. 1, the mobile terminal 11 and the server device 13, the store device 12 and the server device 13, and the server device 13 and the PC 14 each are connected by a solid line to indicate that they can communicate with each other. For example, card information on an electronic point card is transmitted from the mobile terminal 11 to the server device 13. Moreover, an advertisement is distributed from the server device 13 to the PC 14. Moreover, the use history information of the point card is transmitted from the store device 12 to the server device 13. The server device 13 corresponds to the advertisement distribution apparatus of the present invention, and the PC 14 corresponds to the information processing device of the present invention. In the example of FIG. 1, although a case where the system 10 includes one mobile terminal 11, one store device 12 and one PC 14 is illustrated, the disclosed system is not limited to this, and the number of mobile terminals 11, store devices 12, and PCs 14 may be optional. Moreover, the system 10 may include a plurality of server devices 13.

The store device 12 is a device disposed in a store, and for example, is a point-of-sales (POS) terminal that performs an accounting process of the store. The store device 12 may be an information processing device such as a desktop PC, a tablet PC, or a notebook PC. The store provides a service that uses a point card. Examples of the service that uses a point card include providing an incentive such as giving a point or giving a discount corresponding to a stored point and providing benefits such as goods or special information. In the present embodiment, a case where a user presents a point card, and the point card is read by a reader unit 12a installed in the store device 12 to give a point or provide a discount corresponding to a stored point will be described as an example. Card data such as identification information (for example, a user ID) for identifying a card is recorded in the point card. The card data may be recorded in the point card as a one-dimensional code such as a barcode or a two-dimensional code such as a QR (Quick Response: registered trademark) code and may be recorded in a magnetic code or an integrated circuit (IC) chip.

The mobile terminal 11 is a terminal that the user carries and holds. For example, the mobile terminal 11 is a mobile phone, a smartphone, a personal digital assistant (FDA), or the like. An electronic point card is stored in the mobile terminal 11 using an application for managing cards provided from the server device 13, for example. A method of creating an electronic point card is optional. For example, an electronic point card is created in such a way that various point cards are selectably registered in advance by an application and a user selects a point card, captures a code such as a one-dimensional code or a two-dimensional code recorded on the point card using a camera mounted on the mobile terminal 11, and stores image data of the captured code in correlation with the selected point card. A method of creating an electronic point card is not limited to this. For example, a provider of a point card may transmit the type, name, and card data of the point card to the mobile terminal 11, and the mobile terminal 11 may store the type, name, and card data of the point card in correlation.

When an electronic point card is used in a store, the user operates the mobile terminal 11 to allow the card data of the electronic point card to be readable from the outside by radio frequency identification (RFID) or near field communication (NFC) or to display a code such as a one-dimensional code or a two-dimensional code in which the card data is encoded so that the card data is read by the reader unit 12a of the store device 12.

The store device 12 reads the card data of the electronic point card from the mobile terminal 11 to give a point or provide a discount corresponding to a stored point. Moreover, the store device 12 stores the card data of the point card used as history information that represents the use history of the point card and transmits the stored history information to the server device 13.

The server device 13 is an information processing device such as a server computer. The server device 13 provides an application for managing a card, and acquires the card information of the point card registered by the user from the mobile terminal 11 using the application. Moreover, the server device 13 operates a portal site and distributes data of a web page including an advertisement to a requestor when there is a request for an access to the portal site. In this portal site, user IDs are assigned to users, and services corresponding to the respective users are provided when the users access the portal site using the respective user IDs. For example, the portal site provides an application for managing cards.

The PC 14 is a computer used in a house or the like of a user who possesses the mobile terminal 11, and for example, is an information processing device such as a desktop PC, a tablet PC, or a notebook PC. Moreover, the PC 14 is an example of an information processing device, and the information processing device may be a mobile phone, a smartphone, a FDA, or the like. Further, although it is described that the user possesses two terminals of the mobile terminal 11 and the information processing device, the function of the information processing device may be included in the mobile terminal 11 so that the two terminals are realized as one terminal.

The user accesses various sites using the PC 14. For example, the user accesses the portal site provided by the server device 13 using the user ID to use various services. The user ID may be input by the user when accessing the portal site, and the user ID may be stored in the cookie or the like of the PC 14 and be automatically transmitted during the access. An advertisement is displayed on a web page displayed when a service is used. The user recognizes the advertisement displayed on the web page to check an advertisement that the user is interested in.

2. Configuration of Mobile Terminal and Server Device

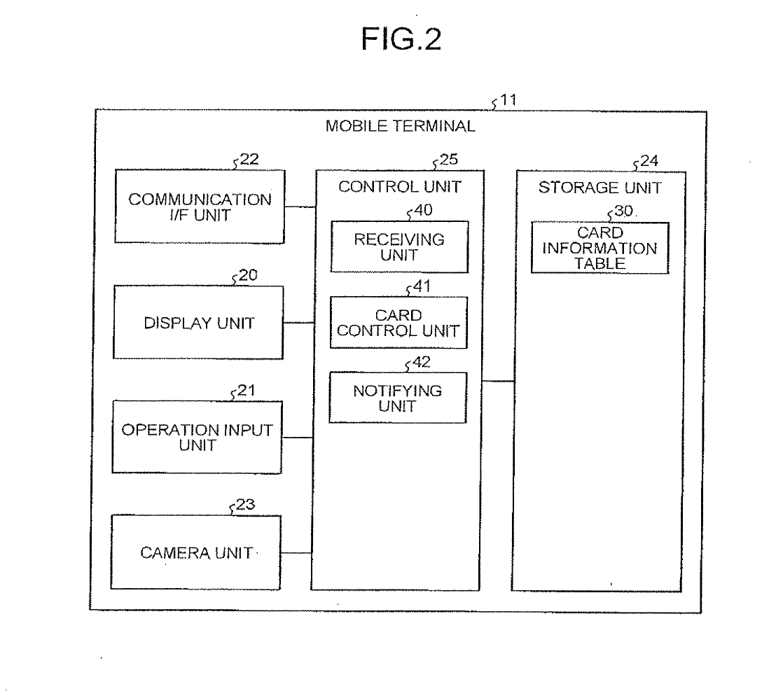

Next, the mobile terminal 11 and the server device 13 according to the embodiment will be described in further detail. First, the configuration of the mobile terminal 11 will be described. FIG. 2 is a diagram illustrating an example of a functional configuration of the mobile terminal according to the embodiment.

As illustrated in FIG. 2, the mobile terminal 11 includes a display unit 20, an operation input unit 21, a communication interface (I/F) unit 22, a camera unit 23, a storage unit 24, and a control unit 25.

The display unit 20 is a display device that displays various types of information. An example of the display unit 20 is a display device such as a liquid crystal display (LCD) or a cathode ray tube (CRT). The display unit 20 displays various types of information. For example, when the card data of an electronic point card is read by the reader unit 12a of the store device 12 as a code, the display unit 20 displays a code screen in which the card data is encoded.

The operation input unit 21 is an input device that inputs various types of information. For example, an example of the operation input unit 21 is an input device such as various buttons provided on the mobile terminal 11 or a transparent touch sensor provided on the display unit 20. In the example of FIG. 2, although the display unit 20 and the operation input unit 21 are separated from each other because the functional configuration is illustrated, the display unit 20 and the operation input unit 21 may be integrated into a device such as a touch panel. Moreover, the operation input unit 21 may be a keyboard, a mouse, or the like. The operation input unit 21 receives the input of operations from the user and inputs operation information indicating the received operation content to the control unit 25.

The communication I/F unit 22 is an interface such as a network interface card (NIC). The communication I/F unit 22 transmits and receives various types of data to and from other devices via a network. For example, the communication I/F unit 22 receives an application for managing cards from the server device 13. Moreover, the communication I/F unit 22 transmits information on the electronic point card.

The camera unit 23 is a device that includes an imaging device and captures an image. The imaging device may be a charge coupled device (CCD) or a complementary metal oxide semiconductor (CMOS). The camera unit 23 is used when capturing the code recorded in the point card to create an electronic point card, for example.

The storage unit 24 is a device that stores various types of information. For example, an example of the storage unit 24 is a semiconductor memory device such as a random access memory (RAM) or a flash memory or a storage device such as a hard disk or an optical disc.

The storage unit 24 stores an operating system (OS) and various programs executed by the control unit for example, the storage unit 24 stores an application for managing cards provided from the server device 13. Further, the storage unit 24 stores various types of data. For example, the storage unit 24 stores a card information table 30.

The card information table 30 is a table that stores information on an electronic point card. For example, in the card information table 30, the card data of a registered point card is stored for each card.

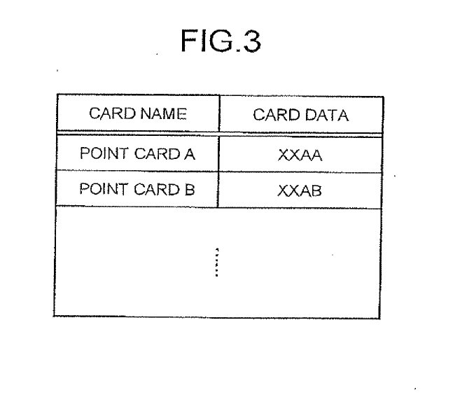

FIG. 3 is a diagram illustrating an example of a data configuration of the card information table according to the embodiment. The card information table 30 illustrated in FIG. 3 includes fields for storing a card name and card data. The names of various point cards are stored in the card name field of the card information table 30, and the card data of point cards is stored in the card data field. In the example of FIG. 3, the card code of “Point Card A.” is “XXAA.” Moreover, “Point Card B” is an electronic point card, and the card code thereof is “XXAB.”

The control unit 25 is a device that controls the mobile terminal 11. For example, the control unit 25 may be an electronic circuit such as a central processing unit (CPU) or a micro-processing unit (MPU), or an integrated circuit such as an application specific integrated circuit (ASIC) or a field programmable gate array (FPGA). The control unit 25 includes an internal memory for storing programs that define various processing procedures and control data and executes various processes with, the aid of the programs and the control data. The control unit 25 functions as various processing units according to the operation of various programs. For example, the control unit 25 includes a receiving unit 40, a card control unit 41, and a notifying unit 42.

The receiving unit 40 performs various types of receiving operations. For example, the receiving unit 40 receives the selection of a point card to be used from the point cards stored in the card information table 30. For example, the receiving unit 40 displays a selection screen for selecting a point card to be used on the display unit 20 and receives the designation of a point card to be used from the selection screen.

The card control unit 41 controls the electronic point card. For example, when a point card is designated on the selection screen, the card control unit 41 allows the card data of the designated point card to be readable, for example, from the outside by RFID or NFC (not illustrated) or displays a code in which the card data is encoded on the display unit 20 so as to be readable from the outside. The store device 12 reads the card data made readable in this manner with the aid of the reader unit 12a.

The notifying unit 42 sends various notifications. For example, the notifying unit 42 notifies the server device 13 of the electronic point card. The notifying unit 42 notifies the server device 13 of information on the point card such as the name and the card data of an electronic point card stored in the card information table 30 at a predetermined point in time, for example. The information on the point card may be notified periodically, for example, daily or monthly, and may be notified when a request for transmission of card data is received from the server device 13. The data of the point card to be notified may be difference data increased from the previous data and data of all point cards stored in the card information table 30 may be transmitted each time.

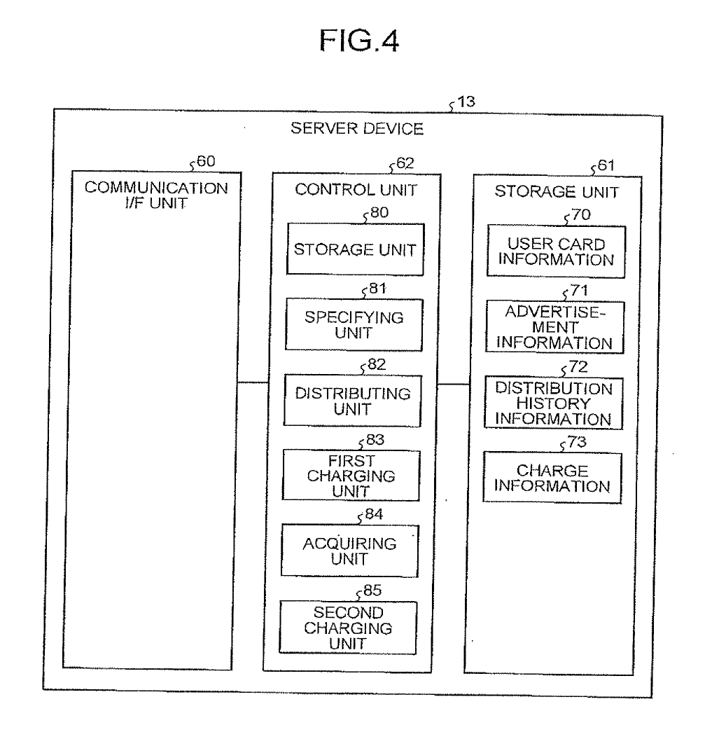

Next, the configuration of the server device 13 will be described. FIG. 4 is a diagram illustrating an example of a functional configuration of the server device according to the embodiment. As illustrated in FIG. 4, the server device 13 includes a communication I/F unit 60, a storage unit 61, and a control unit 62.

The communication I/F unit 60 is an interface such as a NIC. The communication I/F unit 60 transmits and receives various types of data to and from other devices via a network (not illustrated). For example, the communication I/F unit 60 receives the notification of the electronic point card from the mobile terminal 11. Moreover, the communication I/F unit 60 transmits a web page including an advertisement to the PC 14 when there is an access request from the PC 14 to the portal site provided by the server device 13.

The storage unit 61 is a device that stores various types of information. For example, an example of the storage unit 61 is a semiconductor memory device such as a RAM or a flash memory or a storage device such as a hard disk or an optical disc.

The storage unit 61 stores an OS executed by the control unit 62 and various programs used for distribution and charging of an advertisement. Further, the storage unit 61 stores various types of information. For example, the storage unit 61 stores user card information 70, advertisement information 71, distribution history information 72, and charge information 73. These various types of information may be stored to be distributed over a plurality of storage units.

The user card information 70 is data that stores the user who created an electronic point card and information on the electronic point card. The user card information 70 stores store information indicating a store issuing the point card and the identification information of the user as the information of the electronic point card. For example, the user ID of the user who creates the electronic point card, the card name of the point card as the store information, and the card data of the electronic point card are stored in the user card information 70 in correlation.

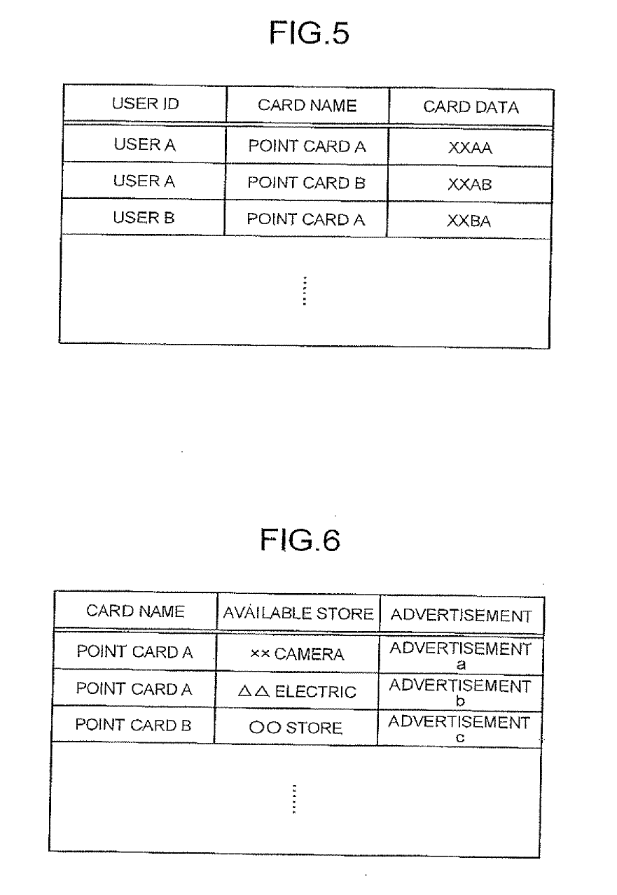

FIG. 5 is a diagram illustrating an example of a data configuration of the user card information according to the embodiment. The user card information 70 illustrated in FIG. 5 includes fields for storing the user ID, the card name, and the card data. The user ID of a user who possesses the point card is stored in the user ID field of the user card information 70, the names of various point cards are stored in the card name field, and the card data of the point cards is stored in the card data field. In the example of FIG. 5, “User A” creates an electronic point card of “Point Card A” and the card code thereof is “XXAA.” Moreover, “User A” creates an electronic point card of “Point Card B” and the card code thereof is “XXAB.” Further, “User B” creates an electronic point card of “Point Card A” and the card code thereof is “XXBA.” The user card information 70 stores data in the respective fields based on the information on the point card notified from the mobile terminal 11.

The advertisement information 71 is data that stores advertisements requested from respective advertisers so as to be displayed and included in a web page. For example, advertisements on stores where the respective point cards can be used are stored in the advertisement information 71.

FIG. 6 is a diagram illustrating an example of a data configuration of the advertisement information according to the embodiment. The advertisement information 71 illustrated in FIG. 6 includes fields for storing the card name, the available store, and the advertisement. The names of various point cards are stored in the card name field of the advertisement information 71, the store names of stores where the point card can be used are stored in the available store field, and advertisements of stores where the point card can be used are stored in the advertisement field. In the example of FIG. 6, “Point Card A.” can be used in “xx Camera,” and an advertisement of the store is “Advertisement a.” Moreover, “Point Card A” can be used in “ΔΔ Electric,” and an advertisement of the store is “Advertisement b.” Further, “Point Card B” can be used in “◯◯ Store,” and an advertisement of the store is “Advertisement C.”

The distribution history information 72 is data that stores a store of which the advertisement is distributed to the user. For example, the user ID of the user, the available store corresponding to the advertisement distributed according to the advertisement information 71, and the distribution date are stored in the distribution history information 72 in correlation.

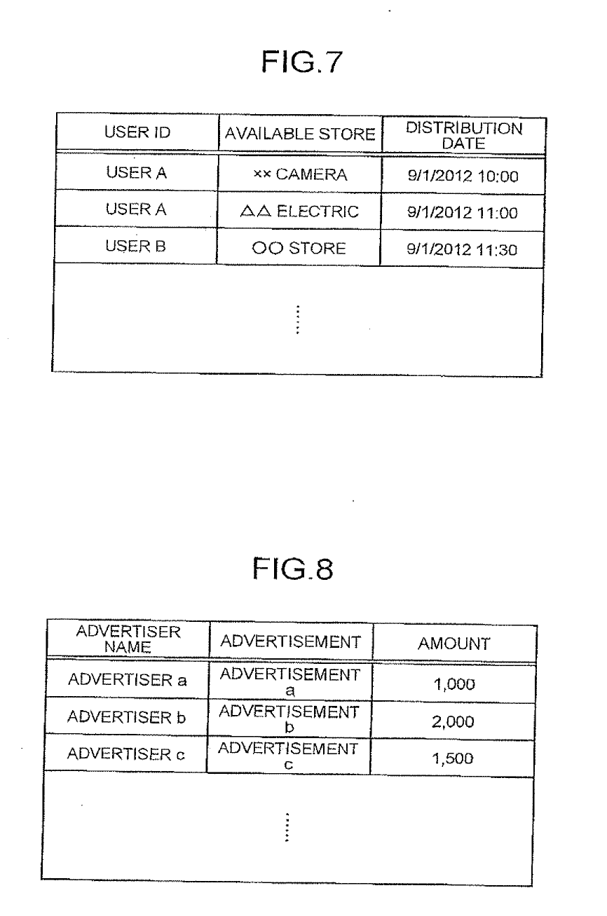

FIG. 7 is a diagram illustrating an example of a data configuration of the distribution history information according to the embodiment. The distribution history information 72 illustrated in FIG. 7 includes fields for storing the user ID, the available store, and the distribution date. The user IDs of users to which an advertisement is distributed are stored in the user ID field of the distribution history information 72, the available stores corresponding to the distributed advertisement are stored in the available store field, and the distribution date when an advertisement is distributed is stored in the distribution date field. In the example of FIG. 7, User A distributes an advertisement at 10:00 (hh:mm) on Sep. 1, 2012 (m/d/yyyy) using “xx Camera” as an available store. Moreover, User A distributes an advertisement at 11:00 on Sep. 1, 2012 using “ΔΔ Electric” as an available store. Further, User B distributes an advertisement at 11:30 on Sep. 1, 2012 using “◯◯ Store” as an available store.

The charge information 73 is data that stores the results of charging on an advertiser. For example, in the charge information 73, the price charged for distributing an advertisement is stored for each advertiser.

FIG. 8 is a diagram illustrating an example of a data configuration of the charge information according to the embodiment. The charge information 73 illustrated in FIG. 8 includes fields for storing an advertiser name, an advertisement, and an amount. The names of advertisers of advertisements are stored in the advertiser name field of the charge information 73, the names of advertisements requested by advertisers are stored in the advertisement field, and the total amount of money charged is stored in the amount field. In the example of FIG. 8, Advertiser a has requested Advertisement a, and the total amount of money charged is 1,000 Yen. Moreover, Advertiser b has requested Advertisement b, and the total amount of money charged is 2,000 Yen. Further, Advertiser c has requested Advertisement c, and the total amount of money charged is 1,500 Yen.

The control unit 62 is a device that controls the server device 13. For example, the control unit 62 may be an electronic circuit such as a CPU or an MPU, or an integrated circuit such as an ASIC or an FPGA. The control unit 62 includes an internal memory for storing programs that define various processing procedures and control data and executes various processes with the aid of the programs and the control data. The control unit 62 functions as various processing units according to the operation of various programs. For example, the control unit 62 includes a storage unit 80, a specifying unit 81, a distributing unit 82, a first charging unit 83, an acquiring unit 84, and a second charging unit 85.

The storage unit 80 stores various types of information. For example, the storage unit 60 stores data in respective fields of the user ID, the card name, and the card data of the user card information 70 based on information on the point card notified from the mobile terminal 11. Here, the user ID may be input, for example, when the server device 13 provides an application for managing a card, the application may be provided to the mobile terminal 11 with the user TD stored, and the user ID may be notified from the mobile terminal 11 together with the information on the point card. Moreover, the user ID may be input from the user to the mobile terminal 11, for example, and the input user ID may be notified. Further, the server device 13 may store the user ID for each user in correlation with the identification information for identifying the mobile terminal 11, for example, the identification information may be notified from the mobile terminal 11, and the user ID corresponding to the notified identification information may be obtained.

The specifying unit 81 specifies various types of information. For example, the specifying unit 81 specifies a user who accesses from the PC 14. The specifying unit 81 specifies the user who uses the information processing device through user authentication, for example. As an example, when there is an access from the PC 14, the specifying unit 81 displays an input screen for inputting a user ID and specifies a user from the user ID input on the input screen. The specification of a user through user authentication may use the user ID stored in the cookie or the like of the PC 14, for example.

The distributing unit 82 distributes various types of information. For example, the distributing unit 82 distributes advertisement information of a store where an electronic point card can be used to the mobile terminal 11 of a user indicated by the user card information 70 so that the advertisement information can be displayed on the PC 14 used by the user who created the electronic point card in the mobile terminal 11. For example, when a portal site provided by the server device 13 is accessed from the PC 14 using a user ID, the distributing unit 82 reads the name of a point card in which the user ID used for the access is stored from the user card information 70. Moreover, the distributing unit 82 reads an advertisement in which the read point card name is stored from the advertisement information 71. Further, the distributing unit 82 distributes data of a web page including the read advertisement to the PC 14 which is the initiator of the access.

In this manner, the web page including the advertisement of the store where the user can use the electronic point card is displayed on the PC 14. In this manner, the server device 13 distributes the advertisement of the available store where the electronic point card possessed by the user to thereby induce the user to visit the store.

When distribution of an advertisement is completed, the distributing unit 82 stores the available store corresponding to the distributed advertisement, the user ID used for the access, and the distribution date of the advertisement information 71 in the distribution history information 72 in correlation.

The first charging unit 83 charges a charge to the advertiser of the advertisement distributed by the distributing unit 82. This charging method may be an impression-based charging method of charging a predetermined amount of money when an advertisement is distributed every predetermined number of times or a click-based charging method of charging money according to the number of clicks on the advertisement. The first charging unit 83 stores the results of charging on each advertiser in the charge information 73.

The acquiring unit 84 acquires various types of information. For example, the acquiring unit 84 acquires history information indicating the use history of the point card at a store. The history information may be acquired by accessing the respective store devices 12 and may be acquired by receiving the history information transmitted from the respective store devices 12. In the present embodiment, the acquiring unit 84 acquires the history information by receiving the history information received from the respective stare devices 12.

The second charging unit 85 charges money to the advertiser of an advertisement when the advertisement succeeds in inducing a user to visit a store. For example, the second charging unit 85 charges money when the history information acquired by the acquiring unit 84 includes the use history of the point card of the user to which an advertisement of a store of which the history information is acquired is distributed. The second charging unit 85 specifies the user ID of the card data of each of the respective point cards included in the history information from the user card information 70, for example. Moreover, the second charging unit 85 obtains an available store correlated with the specified user ID from the distribution history information 72. The second charging unit 85 determines whether the obtained store is identical to the store of which the history information is acquired. When the obtained available store is identical to the store of which the history information is acquired, the second charging unit 85 charges money to the advertiser of the distributed advertiser or the business owner of the store of which the history information is acquired. The second charging unit 85 may charge money according to the period taken until the point card is used in the store corresponding to the advertisement after the advertisement information was distributed. For example, the shorter the period taken until the use of the point card after the distribution of the advertisement information, the larger the amount of money charged by the second charging unit 85. The amount of money charged may change gradually according to the period taken until the use of the point card after the distribution of the advertisement information. Further, for example, the second charging unit 85 may charge money within a predetermined period (for example, within one week) from the distribution date of the advertisement. In this manner, it is possible to prevent an advertisement distributed earlier than the predetermined period from being charged.

Here, the advertiser who sales a product at a store gains profit when a user watches an advertisement posted on a web page and visits the store to purchase the product or the like. When the user watches the distributed advertisement and visits the store to purchase the product or the like using the electronic point card, the available store obtained from the history information is identical to the store of which the history information is acquired. Thus, when the advertisement succeeds in inducing a user to visit a store, the server device 13 can get a reward because the distributed advertisement showed an effect and contributed to the profit of the advertiser.

3. Operation

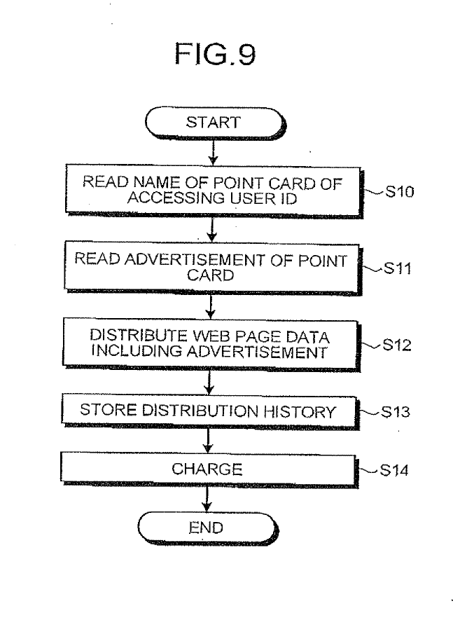

Next, the operation of the system 10 according to the present embodiment will be described. First, the flow of an advertisement distributing process of the server device 13 distributing an advertisement to the PC 14 according to the present embodiment will be described. FIG. 9 is a flowchart illustrating the flow of the advertisement distributing process according to the embodiment. This advertisement distributing process is executed at a predetermined point in time, for example, when a portal site is accessed from the PC 14 using a user ID.

As illustrated in FIG. 9, the distributing unit 82 reads the name of a point card in which the accessed user ID is stored from the user card information 70 (Step S10). The distributing unit 82 reads an advertisement in which the read point card name is stored from the advertisement information 71 (Step S11). Moreover, the distributing unit 82 distributes data of a web page including the read advertisement to the PC 14 which is the initiator of the access (Step S12).

In this manner, the web page including the advertisement of the store where the user can use the electronic point card is displayed on the PC 14.

The distributing unit 82 stores the available store corresponding to the distributed advertisement, the user ID used for the access, and the distribution date in the distribution history information 72 in correlation (Step S13). The first charging unit 83 charges a charge to the advertiser of the advertisement distributed by the distributing unit 82 (Step S14), and the process ends.

In this manner, the server device 13 can get a reward from the advertiser because the server device 13 can induce the user to visit the store by distributing an advertisement of the store where the user can use the electronic point card to the PC 14 used by the user.

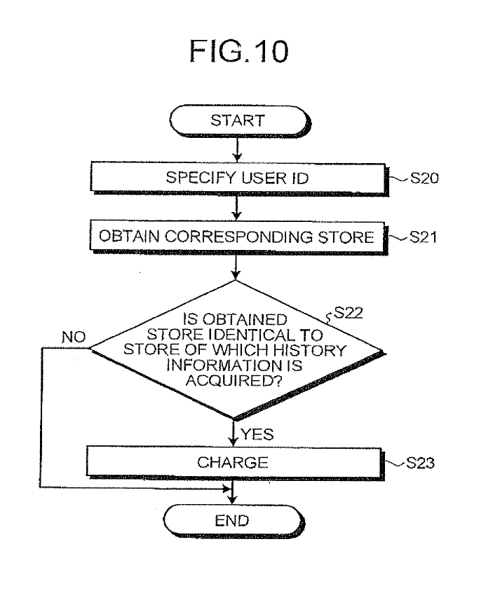

Next, the flow of the charging process of charging money for the server device 13 inducing the user to visit the store according to the present embodiment will be described. FIG. 10 is a flowchart illustrating the flow of the charging process according to the embodiment. This charging process is executed at a predetermined point in time, for example when the history information indicating the use history of the point card of the store is acquired.

As illustrated in FIG. 10, the second charging unit 85 specifies the user ID of the card data of each of the respective point cards included in the acquired history information from the user card information 70 (Step S20). The second charging unit 85 obtains an advertised store correlated with the specified user ID from the distribution history information 72 (Step S21). The second charging unit 85 determines whether the obtained advertised store is identical to the store of which the history information is acquired (Step S22). When the obtained advertised store is identical to the store of which the history information is acquired (Yes in Step S22), the second charging unit 85 charges money to the advertiser of the distributed advertiser or the business owner of the store (Step S23), and the process ends. When the obtained advertised store is not identical to the store of which the history information is acquired (No in Step S22), the process ends.

4. Advantages

In this manner, the server device 13 stores the user card information 70 that stores the store information and the identification information of the user as the information on the electronic point card issued to the mobile terminal 11 of the user. Moreover, the server device 13 stores the advertisement information 71 that stores the advertisement information of the store. The server device 13 specifies the user who uses the PC 14 through user authentication. When the specified user is a user identified by the identification information stored in the user card information 70, the server device 13 reads the advertisement information of the store corresponding to the point card issued to the mobile terminal 11 of the user from the advertisement information 71 and distributes the advertisement information to the PC 14. In this manner, the server device 13 can allow the user possessing the point card to watch the advertisement of the store to induce the user to visit the store by distributing the advertisement of the store where the electronic point card can be used to the PC 14 used by the user who created the electronic point card.

Moreover, the server device 13 charges money to the advertiser of the distributed advertisement information. In this manner, the server device 13 can get a reward by distributing the advertisement of the store where the electronic point card can be used to the PC 14 used by the user.

Moreover, the server device 13 acquires the history information indicating the use history of the point card at the store. Moreover, the server device 13 charges money when the acquired history information includes the use history of the point card of the user to which the advertisement of the store of which the history information is acquired is distributed. In this manner, the server device 13 can get a reward for successfully inducing the user to visit the store.

Moreover, the server device 13 charges money according to a period taken until the paint card is used at the store corresponding to the advertisement after the advertisement information was distributed. In this manner, the server device 13 can increase the amount of money charged when the advertisement has high power to appeal to users.

5. Others

The exemplary embodiments of the present disclosure have been described above in detail with reference to the accompanying drawings, but the above embodiments are exemplary, and the present invention can be implemented in other forms in which various changes or improvements are made from the embodiments described in the detail description of the present invention based on knowledge of one skilled in the art.

For example, in the embodiment, although a case where the user obtains an advertisement of a store where the electronic point card can be used from the user card information 70 and the advertisement information 71 using the name of the point card has been described, the present invention is not limited to this. For example, a type code indicating the point card may be assigned to each of various types of point cards, and the user can obtain the advertisement of the store where the electronic point card can be used using the user card information 70 and the advertisement information 71 that are correlated using the type code.

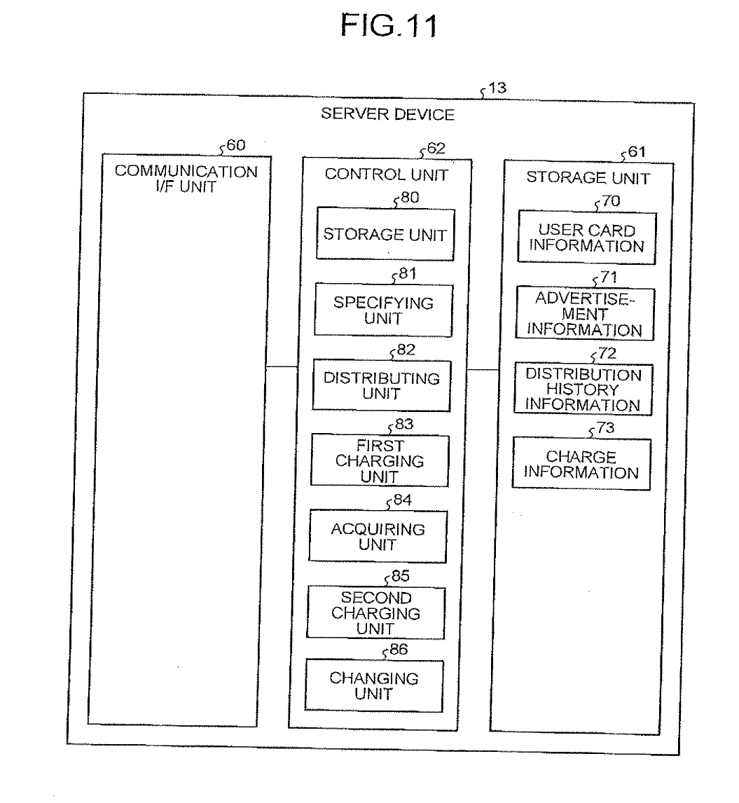

Moreover, in the embodiment, although a case where money is charged according to the period taken until the point card is used at the store corresponding to the advertisement after the advertisement information was distributed has been described, the present invention is not limited to this. For example, when a point is added according to the use of the point card, the point addition rate may be changed according to the period taken until the point card is used at the store corresponding to the advertisement after the advertisement information was distributed. The point may be managed by the server device 13 and may be managed by another server device and the server device 13 may notify the point addition rate. FIG. 11 is a diagram illustrating another example of the functional configuration of the server device according to the embodiment. In the example of FIG. 11, the control unit 62 further includes a changing unit 86 that changes the point addition rate. For example, the changing unit 86 may be configured such that the shorter the period taken until the use of the point card after the distribution of the advertisement information, the higher the point is added. The point added may be changed gradually according to the period taken until the use of the point card after the distribution of the advertisement information. Moreover, for example, the changing unit 86 may add the point within a predetermined period (for example, within one week) from the distribution date of the advertisement. In this manner, since a higher point is given to the user who uses the point card immediately upon watching the advertisement, it is possible to give the user a motivation to visit the store as quick as possible and to induce the user to visit the store.

In the embodiment, when the distribution of the advertisement is completed, the available store corresponding to the distributed advertisement and the user in used for the access of the advertisement information 71 are stored in the distribution history information 72 in correlation. When the available store stored in the distribution history information 72 is the store of which the history information is acquired, money is charged by determining that the history information includes the use history of the point card of the user to which the advertisement of the store of which the history information is acquired is distributed. However, the present invention is not limited to this. For example, the available store corresponding to the distributed advertisement and the electronic card code of the user to which the advertisement is distributed may be stored in the distribution history information 72, and money may be charged when the available store stored in the distribution history information 72 is identical to the store of which the history information is acquired, and the card code is included in the history information.

The server device 13 may be realized as a plurality of server computers, and the configuration of the server device 13 may be flexibly changed depending on functions. For example, an external platform may be called by an application programming interface (API) or network computing and then implemented.

Furthermore, “unit” described in the claims may be replaced with a “section,” a “module,” or a “circuit.” For example, a “searching unit” may be replaced with a “searching section” or a “searching circuit.”

The advertisement distribution apparatus according to the present application can show advertisements of stores to a user possessing a point card to induce the user to visit the stores.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An advertisement distribution apparatus comprising:
a card information storage unit that stores store information and identification information of the user as information on an electronic point card issued to a mobile terminal of a user;
an advertisement storage unit that stores advertisement information of the store;
a specifying unit that specifies a user who uses an information processing device through user authentication; and
a distributing unit that reads advertisement information of a store corresponding to the point card issued to the mobile terminal of the user from the advertisement storage unit and distributes the advertisement information to the information processing device when the user specified by the specifying unit is a user identified by the identification information stored in the card information storage unit.

2. The advertisement distribution apparatus according to claim 1, further comprising:
a first charging unit that charges money to an advertiser of the advertisement information distributed by the distributing unit.

3. The advertisement distribution apparatus according to claim 1, further comprising:
an acquiring unit that acquires history information indicating a use history of the point card at a store; and
a second charging unit that charges money when the history information acquired by the acquiring unit includes the use history of the point card of the user to which the advertisement information on the store of which the history information is acquired is distributed.

4. The advertisement distribution apparatus according to claim 3, wherein
the second charging unit charges money according to a period taken until the point card is used at the store corresponding to the advertisement after the distribution of the advertisement information.

5. The advertisement distribution apparatus according to claim 1, further comprising:
a changing unit that changes a point addition rate according to a period taken until the point card is used at the store corresponding to the advertisement after the distribution of the advertisement information.

6. An advertisement distribution method executed by a computer, the method comprising:
specifying a user who uses an information processing device through user authentication; and
when the specified user is a user identified by identification information stored in a card information storage unit that stores store information as information on an electronic point card issued to a mobile terminal of a user and identification information of the user, reading the advertisement information of the store corresponding to the point card issued to the mobile terminal of the user from an advertisement storage unit that stores the advertisement information of the store and distributing the advertisement information to the information processing device.

7. A computer-readable recording medium having stored therein an advertisement distribution program for causing a computer to execute a process, the process comprising:
specifying a user who uses an information processing device through user authentication; and
when the specified user is a user identified by identification information stored in a card information storage unit that stores store information as information on an electronic point card issued to a mobile terminal of a user and identification information of the user, reading the advertisement information of the store corresponding to the point card issued to the mobile terminal of the user from an advertisement storage unit that stores the advertisement information of the store and distributing the advertisement information to the information processing device.
